(19) United States
(12) Patent Application Publication
(10) Pub. No.: US 2012/0120939 A1
(43) Pub. Date: May 17, 2012

(54) METHOD AND DEVICE FOR CONVEYING TRAFFIC IN A PROXY MOBILE IP SYSTEM

(75) Inventor: Jouni Korhonen, Riihimaki (FI)

(73) Assignee: NOKIA SIEMENS NETWORKS OY, Espoo (FI)

(21) Appl. No.: 13/384,608

(22) PCT Filed: Jul. 24, 2009
(86) PCT No.: PCT/EP09/59611

§ 371 Date: Feb. 1, 2012

(51) Int. Cl. H04W 40/00

(52) U.S. Cl. 370/338

(57) ABSTRACT

A method and a device for conveying traffic by a network element comprising a first router instance and a second router instance are provided, wherein the traffic is conveyed between the first router instance and a network via a mobility anchor; and wherein the traffic is directly conveyed between the second router instance and the network. Furthermore, a communication system is suggested comprising said device.

The invention relates to a method and to a device for conveying traffic by a network element, in particular a media access gateway. Also, a corresponding communication system is suggested.

In the PMIPv6 protocol, all IP traffic is tunneled to and from a mobile node (MN) via a mobile access gateway (MAG) and a local mobility anchor (LMA). With the overall traffic volumes significantly increasing, the LMA becomes a bottleneck as it further concentrates traffic from multiple MAGs.

The problem to be solved is to overcome the disadvantage stated above and in particular to provide an efficient solution to avoid or to reduce the bottleneck situation at the LMA.

This problem is solved according to the features of the independent claims. Further embodiments result from the depending claims.

In order to overcome this problem, a method for conveying traffic in a network element is provided, said network element comprising a first router instance and a second router instance,
wherein the traffic is conveyed between the first router instance and a network via a mobility anchor;
wherein the traffic is directly conveyed between the second router instance and the network.

Conveying traffic in particular relates to conveying traffic to and/or from the network.

The first router instance and the second router instance may each comprise a router function or interface that is located at or associated with the network element. Such router instance can be a physical router or a logical routing functionality. The network element may comprise several (i.e. more than two) routers.

The traffic may in particular be forwarded or conveyed towards or from the network via the mobility anchor. Such forwarding to the network can be provided by said first router instance. The first router instance may also be referred to as “LMA router”. In addition or as an alternative, traffic can be conveyed directly to the network—without any detour via said mobility anchor; this is conducted by said second router, which may be referred to as local network router.

The mobility anchor may be a local mobility anchor (LMA).

Hence, the approach suggested enables a local breakout solution for PMIPv6 via said second router instance.

The approach provided relates to, e.g., IETF IP mobility and 3GPP Evolved Packet Core that use PMIPv6 based protocols. It is noted, however, that the solution is applicable in any other PMIPv6 scenario. It suggests a solution how to provide local IP access for mobile nodes (MNs) directly from the MAG.

As a huge amount of IP services accessed are local with regard to the IP topology, it is advantageous to bypass the

LMA for a bulk of IP traffic. Hence, the “bulk” traffic may exit immediately at the MAG to the public Internet (also referred to as “local breakout”). This feature, however, is not supported by the current PMIPv6 protocol.

In an embodiment, said network element is a mobile access gateway.

Said mobile access gateway (MAG) may comprise said first router instance and said second router instance.

In another embodiment, the traffic conveyed comprises IP traffic, in particular IPv6 traffic.

It is noted that IPv4 can be used as well. However, in such case, IPv4 support for proxy mobile IPv6 is required as well as an implementation according to RFC3442.

In a further embodiment, the network is the Internet.

In a next embodiment, the network element conveys traffic to and/or from at least one mobile node.

Said mobile node (MN) may be any device with a wired or a wireless or a radio interface capable of processing information to/from the network element. The MN may be a user equipment, a cellular phone or a cellular device deployed with a piece of hardware, e.g., a personal digital assistant, a computer, or the like.

Hence, the network element may communicate with the MN via its first router instance and/or via its second router instance.

It is also an embodiment that the network element is configured with addresses used for conveying traffic via the first router instance or via the second router instance.

Such addresses may be physical addresses of the network, it may also comprise prefixes used for summarizing several addresses. For the first router instance and for the second router instance, separate addresses are used for configuration purposes. As an option, a particular information may indicate that all other addresses (not defined otherwise) may be used for processing traffic via a particular router.

Pursuant to another embodiment, the network element is dynamically configured by the mobility anchor, in particular utilizing a proxy binding mechanism.

Such proxy binding mechanism may comprise messages exchanged between the network element and the mobility anchor. The network element is thus informed by the mobility anchor about addresses and/or prefixes to be used by the first router instance and/or addresses and/or prefixes to be used by the second router instance. In particular, the second router instance may use all addresses that are not defined otherwise for conveying traffic directly to the network (and hence not routed via the mobility anchor).

According to an embodiment, the network element is statically and/or manually configured, in particular via a policy interface.

According to another embodiment, the first router instance informs a mobile node about routes or addresses that are utilized for conveying traffic via the mobility anchor.

In yet another embodiment, the second router instance informs the mobile node about routes or addresses that are utilized for conveying traffic directly towards the network.

In this case, the traffic conveyed by the second router instance does not have to cope with the detour via said mobility anchor.

According to a next embodiment, the second router instance informs the mobile node by including an additional route information indicating that all other traffic (not specified otherwise) is to be conveyed directly towards the network via this second router instance.

Hence, the mobile node determines by the prefix or address of traffic to be sent towards the network, which router instance is to be used. If the address or prefix matches the predetermined addresses or prefixes that are set for the first router instance, the mobile node sends such traffic towards the first router instance, which forwards it to the network via the mobility anchor detour. If, e.g., the address or prefix used for a particular traffic is not defined otherwise, the mobile node sends the traffic to the network via the second router instance (without any mobility anchor detour). It is noted that the IPv6 first hop router selection is provided according to IPv6 standard as described in RFC4861 extended and/or updated by RFC4191.

Pursuant to yet another embodiment, the first router instance and/or the second router instance inform(s) the mobile node via a router advertisement message.

A router advertisement (RA) message can be used to convey said route information or said routes or addresses towards the mobile node(s).

The problem stated above is also solved by a device comprising and/or being associated with a processor unit and/or a hard-wired circuit and/or a logic device that is arranged such that the method as described herein is executable thereon.

According to an embodiment, the device is a communication device, in particular a or being associated with a mobile access gateway.

The problem stated supra is further solved by a communication system comprising the device as described herein.

The problem is also solved by a device
comprising a first router instance for conveying traffic to and/or from a network via a mobility anchor, in particular a LMA;
comprising a second router instance for conveying traffic to and/or from a network without a detour via the mobility anchor.

The first router instance and the second router instance are each connected to a mobile node for conveying traffic to and/or from the mobile node and the network. The network may preferably be the Internet.

Embodiments of the invention are shown and illustrated in the following figures:

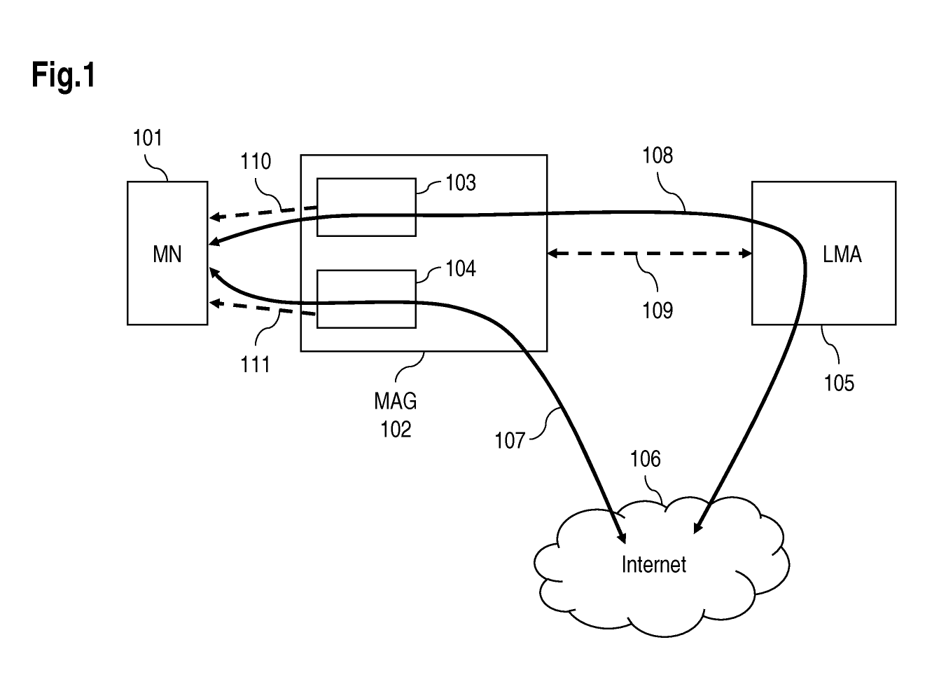

FIG. 1 shows a local IP access architecture based on PMIPv6, wherein a mobile node is connected via a wireless (radio) interface to a media access gateway, which comprises an LMA router that conveys traffic to the Internet via an LMA, and a local IP router that conveys traffic to the Internet without redirecting it to the LMA;

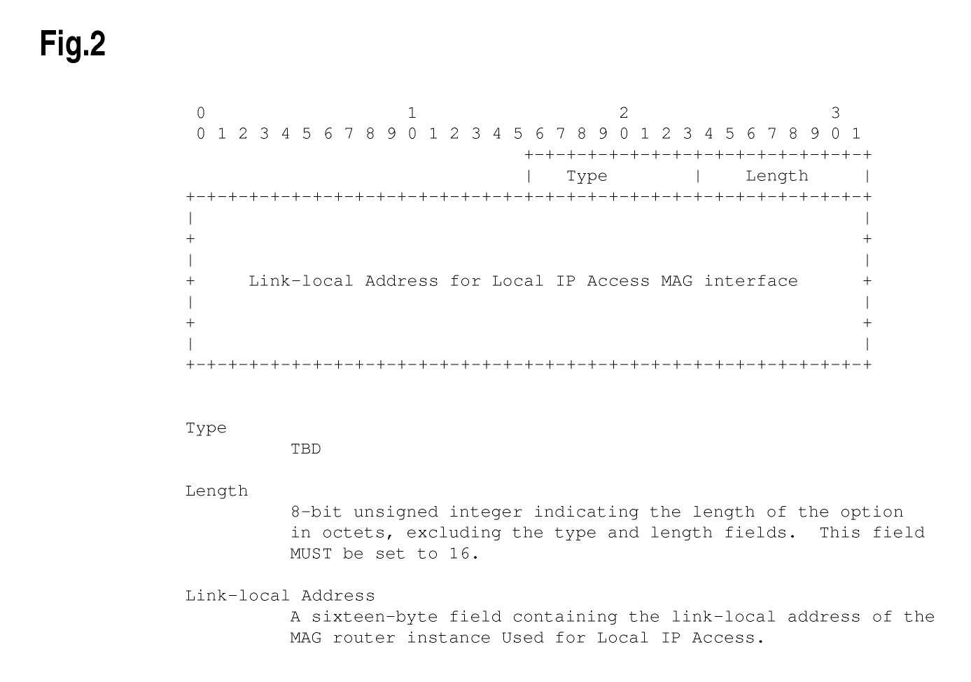

FIG. 2 shows an exemplary format of the Link-Local Address for the Local IP Access to be added as a new mobility option;

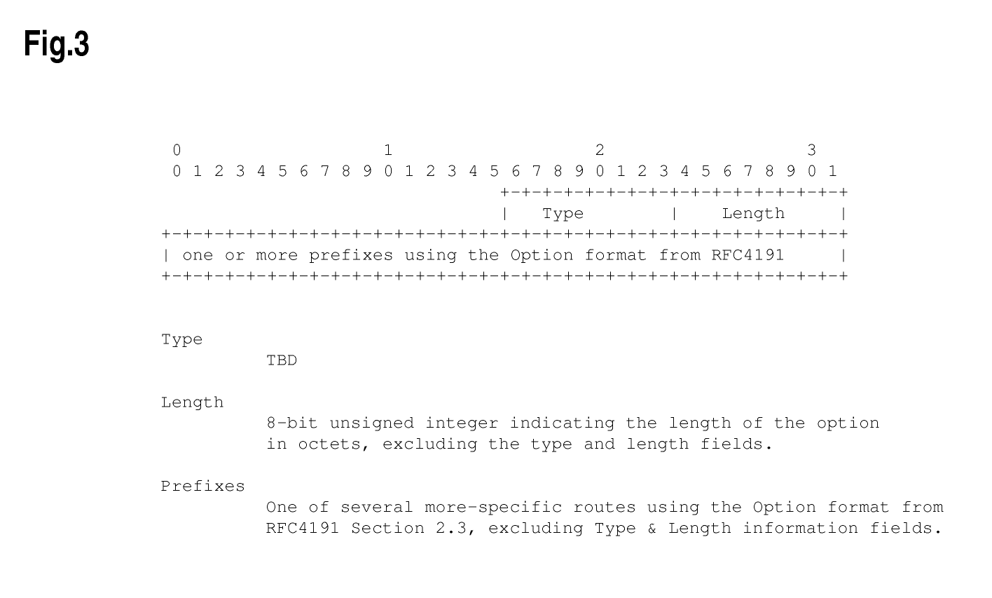

FIG. 3 shows an exemplary format of the Link-Local Address for the access via the LMA to be added as a new mobility option.

The approach suggested herein provides an efficient solution for local IP access in a mobile access gateway (MAG). The solution can be implemented based on the PMIPv6 protocol, e.g., by providing adjustments to the currently existing definition of the PMIPv6 protocol messages. As an alternative, the solution can be implemented without any changes to the existing PMIPv6 protocol Proxy Binding Update messages and Acknowledgement messages. This can be achieved, e.g., by downloading policy rules to the MAG using some other interface (for example, based on some AAA protocol) that allow the MAG to perform the local IP access decision. The third alternative is to statically configure policy rules in the MAG using, for example, an administrator's management interface.

A mobile node (MN) may preferably be capable of handling multiple IPv6 routers on the same link. If the mobile node does not have such functionality, the approach suggested will still ensure cooperation between the MN and the MAG in the conventional way. In other words, the solution provided is compliant with legacy equipment.

### Embodiment Adjusting Current PMIPv6 Protocol

The solution described may be based on RFC4191, which provides a functionality to advertise preferences of default routers in IPv6 router advertisements (RAs). Also, more detailed routes using the same RFC4191 functionality are specified. An implementation according to RFC4191 avoids deep packet inspection and complex traffic rules in the MAG in order to distinguish and separate traffic to be processed.

It is thus suggested to provide a MAG that appears as a first hop router (of several routers) on the same link where the MN is located. In this regard it would be of significant advantage to update the PMIPv6 protocol RFC5213 definition of the MAG and the link model to provide a functionality that supports several routers on a single link.

The PMIPv6 protocol can be extended by adding two new mobility options that are used to transfer a Link-Local Address of the local IP access router interface from the LMA to the MAG and to describe prefixes that shall always be routed via the LMA. These options are described below in detail. However, the options may be replaced by a local static configuration in the respective MAG.

Using “default router preferences” and “more specific routes” (which may be based on RFC4191), the MAG is able to advertise different routes for local IP access and for default IP access. The RA sent from the MAG to the LMA may comprise information for non-local IP traffic that will be routed to the LMA (as done before, here referred to as “default router preferences”). The “more specific routes” in the RA may comprise information regarding prefixes that are subject to a specific treatment. A MN that does not understand this RFC4191 extension may fall back to normal IPv6 next-hop behavior and it may always route its traffic towards the router (in the MAG) that forwards the traffic to the LMA.

The configuration of the RA using RFC4191 and local IP access could be as follows:
(1) RA “Prf” bits are set to “00”, i.e. the medium preference;
(2) RA router lifetime is non-zero;
(3) At least two router information options can be included in every RA. One option may indicate where to route by default, i.e. a “::/0” route, and one or more options may indicate where to route more specific traffic.

Typically, the default “::/0” route can point to the local IP access router (which may be a router instance within or associated with the MAG). The more specific routers may point to the router instance that forwards traffic to the LMA (e.g., the legacy MAG router instance).

The RA is sent from the MAG router instance interface that routes traffic to the LMA.

A proxy binding update (PBU) can be performed between the MAG and the LMA. The PBU may indicate to the LMA that local IP access is supported by the MAG. This can be achieved either by adding a new bit into the PBU flags or by adding a Link-Local Address for the Local IP Access mobility option into the PBU.

FIG. 2 shows an exemplary format of the Link-Local Address for the Local IP Access to be added as a new mobility option.

This new Mobility Option to specify the more specific routes that still may have to be forwarded via the LMA could be added according to an exemplary format shown in FIG. 3.

FIG. 1 shows a local IP access architecture based on PMIPv6. A MN 101 is connected via a wireless (radio) interface to a MAG 102. The MAG 102 comprises an LMA router 103 that conveys traffic to the Internet 106 via an LMA 105 (see route 108). Also, the MAG 102 comprises a local IP router 104 that conveys traffic to the Internet 106 without redirecting it to the LMA (see route 107).

A proxy binding update 109 is performed between the MAG 102 and the LMA 105 indicating a support for the Local IP Address. A PBA is sent with a Local IP Address router Local-Link Address and optionally further specific routes. This PBU allows to dynamically configure the MAG with addresses or prefixes used by traffic that need to be conveyed via the LMA.

A message 110 indicates a RA sent from the LMA router 103 to the MN 101. The router lifetime is set to non-zero. The RA may include more specific routes from the MN 101 to the LMA router 103 for traffic that needs to be conveyed via the LMA 105.

Hence, the RA 110 from the LMA router 103 to the MN 101 comprises:
lifetime>0;
prefix information: prefix for the MN;
route information: all specific prefixes (except for “::/0”) that need to be conveyed via the LMA 105.

A message 111 indicates a RA sent from the local IP router 104 to the MN 101. In the RA, the lifetime for this local IP router 104 is set to zero and the RA may comprise an additional route “::/0” indicating that all other traffic (that is not forwarded to the LMA router 103) can be forwarded to the local IP router 104. Hence, the RA 111 from the IP router 104 to the MN 101 comprises:
lifetime=0;
route information: “::/0” (i.e. all other traffic) with high preference.

For the MN 101, both messages 110 and 111 appear to arrive on a single (logical) link.

It is noted that the LMA router 103 and/or the local IP router 104 may be implemented as (logical) router instances, in particular as router interfaces. The MAG 102 may comprise more than two such routers or router instances.

When the traffic exits the local IP router, there may have to be network address translation (NAT) to be conducted at the MAG for the local IP traffic, because the prefix assigned to the MN may be topologically anchored with the LMA. If the MN has multiple prefixes, the MAG may “advertise” local prefixes to the MN and it may point out that some prefixes are not supported with regard to mobility. E.g., such prefixes could be used for local IP access without NAT. In an exemplary scenario, the network administrator providing IP address planning may be sufficiently knowledgeable and the MN may support RFC3484 defined source address selection. Hence, proper addressing may work without any problem for most cases.

Hereinafter, two scenarios are summarized for the MN (not) capable of performing the RFC4191 functionality as described:
(a) The MN is capable of performing a functionality according to RFC4191:
   The MN 101 “sees” both RAs 110 and 111 (from both routers 103 and 104);
   The MN 101 configures the LMA router 103 as default router, because of the lifetime being larger than 0 and because of the prefix of the RA 110;
   The MN 101 configures “more specific routes” received in the RA 110 from the LMA router 103. These “more specific routes” describe the traffic that needs to be conveyed via the LMA 105 and is to be routed by the LMA router 103;
   The MN 101 examines the RA 111 from the local IP router 104 even as its lifetime is 0; however, local IP router 104 is not added to the MN's default routers because of the lifetime amounting to 0. The MN 101 configures a default route “::/0” with high preference to go to this local IP router 104;
   Hence, when the MN 101 sends traffic to destinations that need to be conveyed via the LMA 105, the MN 101 forwards such traffic to the LMA router 103. In all other cases, traffic is forwarded to the local IP router 104 (as it is the default path for “all other” traffic).
(b) The MN is not capable of performing a functionality according to RFC4191:
   The MN 101 “sees” both RAs 110 and 111 (from both routers 103 and 104);
   The MN 101 configures the LMA router 103 as the default router, because of the lifetime being larger than 0 and because of the prefix of the RA 110;
   The MN 101 ignores all RFC4191 functionality, i.e. “route info” options that are conveyed with both RAs 110 and 110;
   All traffic goes to the LMA router 103, the local IP router 104 is ignored because its lifetime is set to 0.

Advantageously, the approach provided supports PMIPv6 with legacy hosts and does not require deep packet inspection to be conducted at the MAG.

### Embodiment Without Adjusting the Existing PMIPv6 Protocol

As indicated above, adjusting the PMIPv6 is only one option. The approach could also be implemented without any changes applied to the PMIPv6 protocol. Preferably, also in this case, the MAG is adapted to support local IP access.

Hence, the more specific route information can be supplied to the MAG manually or via a policy interface (e.g., a 3GPP PCC type of interface). It is noted that PCC is defined based on 3GPP TS 23.203 and, e.g., conveys and defines policy rules for IP traffic. The PCC can thus be also utilized for a dynamic configuration of the MAG.

The RA information and the link-local address for the local IP access router instance can be configured manually in/for each MAG.

Beyond that, the embodiment corresponds to the one discussed above.

The solution is compliant with IPv6 from a MN's point of view and from a MAG's point of view.

### List of Abbreviations

### 3GPP 3rd Generation Partnership Project

### AAA Authentication, Authorization, Accounting

### CP Control Plane

### ESP Encapsulating Security Protocol

### GRE Generic Routing Encapsulation

### GTP GPRS Tunneling Protocol

### IETF Internet Engineering Task Force

### IP Internet Protocol

### IPv# Internet Protocol Version # (#=4 or 6)

### LMA Local Mobility Anchor

### LTE Long Term Evolution

### MAG Mobile Access Gateway

### MN Mobile Node

### NAT Network Address Translation

### PBA Proxy Binding Acknowledgement

### PBU Proxy Binding Update

### PCC Policy and Charging Control

### PDN-GW Packet Data Network Gateway

### PMIPv6 Proxy Mobile IPv6

### RA Router Advertisement

### Rel-8 Release 8

### RFC Request for Comments

### SA Security Association

### SB Service Blade

### SPI Security Parameter Index

UE User Equipment (same as the MN)
UP User Plane

1. A method for conveying traffic by a network element comprising a first router instance and a second router instance,
wherein the traffic is conveyed between the first router instance and a network via a mobility anchor;
wherein the traffic is directly conveyed between the second router instance and the network.

2. The method according to claim 1, wherein said network element is a mobile access gateway.

3. The method according to claim 1, wherein the traffic conveyed comprises IP traffic, in particular IPv6 traffic.

4. The method according to claim 1, wherein the network is the Internet.

5. The method according to claim 1, wherein the network element conveys traffic to and/or from at least one mobile node.

6. The method according to claim 1, wherein the network element is configured with addresses used for conveying traffic via the first router instance or via the second router instance.

7. The method according to claim 6, wherein the network element is dynamically configured by the mobility anchor, in particular utilizing a proxy binding mechanism.

8. The method according to claim 6, wherein the network element is statically and/or manually configured, in particular via a policy interface.

9. The method according to claim 6, wherein the first router instance informs a mobile node about routes or addresses that are utilized for conveying traffic via the mobility anchor.

10. The method according to claim 9, wherein the second router instance informs the mobile node about routes or addresses that are utilized for conveying traffic directly towards the network.

11. The method according to claim 10, wherein the second router instance informs the mobile node by including an additional route information indicating that all other traffic that is not specified otherwise is to be conveyed directly towards the network via this second router instance.

12. The method according to claim 1, wherein the first router instance and/or the second router instance inform(s) the mobile node via a router advertisement message.

13. A device comprising and/or being associated with a processor unit and/or a hard-wired circuit and/or a logic device that is arranged such that the method according to claim 1 is executable thereon.

14. The device according to claim 13, wherein said device is a communication device, in particular a or being associated with a mobile access gateway.

15. A communication system comprising the device according to claim 13.
